(19) United States
(12) Patent Application Publication
(10) Pub. No.: US 2016/0320887 A1
(43) Pub. Date: Nov. 3, 2016

(54) SCREEN ASSEMBLY AND MOBILE DEVICE HAVING SAME

(71) Applicant: Xiaomi Inc., Beijing (CN)

(72) Inventors: Guosheng LI, Beijing (CN); Anyu LIU, Beijing (CN); Yu ZHANG, Beijing (CN)

(21) Appl. No.: 15/079,977

(22) Filed: Mar. 24, 2016

(30) Foreign Application Priority Data
Apr. 28, 2015 (CN) 201510209636.1

(51) Int. Cl. G06F 3/041; G09G 3/36; G02F 1/1333

(52) U.S. Cl. CPC G06F 3/0412; G02F 1/13338; G09G 3/36; G09G 2300/0452; G09G 2300/0426; G09G 2320/0626; G09G 2360/144; H04W 88/02

(57) ABSTRACT

A screen assembly includes a display region, a light sensor arranged within the display region and configured to acquire data representing ambient light of the screen assembly, and a data transmission wire coupled to the light sensor at one end and a processing component at another end. The data transmission wire is configured to transmit the data acquired by the light sensor to the processing component.

The present application is based upon and claims priority to Chinese Patent Application No. 201510209636.1, filed Apr. 28, 2015, the entire contents of which are incorporated herein by reference.

### TECHNICAL FIELD

The present disclosure is related to terminal technology and, more particularly, to a screen assembly and a mobile device having a screen assembly.

### BACKGROUND

In the related art, a mobile device is typically equipped with a light sensor, for sensing ambient light of the mobile device so as to suitably adjust brightness of the screen of the mobile device. This saves electric power for the device, and moreover, provides a suitable brightness to the user.

### SUMMARY

In accordance with the present disclosure, there is provided a screen assembly including a display region, a light sensor arranged within the display region and configured to acquire data representing ambient light of the screen assembly, and a data transmission wire coupled to the light sensor at one end and a processing component at another end. The data transmission wire is configured to transmit the data acquired by the light sensor to the processing component.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic view of a screen assembly of a mobile device according to related art.

FIG. 2 is a schematic view of a screen assembly of a mobile device according to an exemplary embodiment of the present disclosure.

FIG. 3 is a schematic view of a screen assembly of a mobile device according to another exemplary embodiment of the present disclosure.

FIG. 4 is a schematic view of a screen assembly of a mobile device according to another exemplary embodiment of the present disclosure, with a partial enlarged view of a touch screen structure of the screen assembly.

FIG. 5 is a schematic view of a screen assembly of a mobile device according to another exemplary embodiment of the present disclosure, with a partial enlarged view of a touch screen structure of the screen assembly.

FIG. 6 is a cross-sectional view of layers of a screen assembly of a mobile device according to an exemplary embodiment of the present disclosure.

FIG. 7 is a cross-sectional view of layers of a screen assembly of a mobile device according to another exemplary embodiment of the present disclosure.

FIG. 8 is a schematic view of a screen assembly of a mobile device according to another exemplary embodiment of the present disclosure, with a partial enlarged view of a color filter of the screen assembly.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

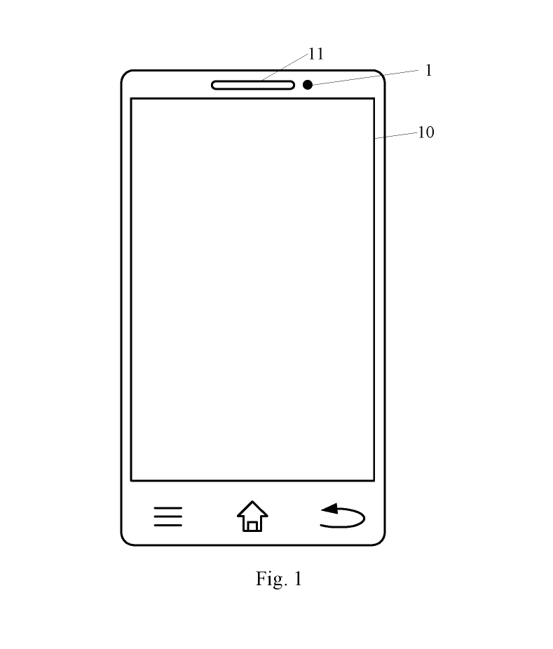

FIG. 1 is a schematic view of a screen assembly of a mobile device according to related art. As shown in FIG. 1, in the related art, the screen assembly of the mobile device is provided with a hole, typically at a position as shown in FIG. 1, that is, on the upper side of a display region 10 of the screen assembly and, for example, on either side of an earphone 11. A light sensor 1 is amounted at the position corresponding to the hole. Thereby, the light sensor 1 can sense ambient light of the mobile device through the hole.

However, in the screen assembly shown in FIG. 1, the hole affects the integrity of the mobile device and reduces strength of the screen assembly of the mobile device. Further, the hole may affect the aesthetic appearance of the mobile device. Moreover, the size of the hole is usually limited to reduce the influence of the hole. As a result, the light sensor 1 has a limited light incident angle for light detection, and thus the mobile device's capability of adjusting the brightness of the screen according to the change of the ambient light can be limited, which influences the user's experience. Finally, while it would be ideal to adjust the brightness of the screen directly with respect to the display region 10, since the light sensor 1 is disposed at a certain distance away from the display region 10, the light sensor 1 detects an ambient light condition different from the actual ambient light condition at the display region 10, which also influences the adjustment of the brightness of the screen.

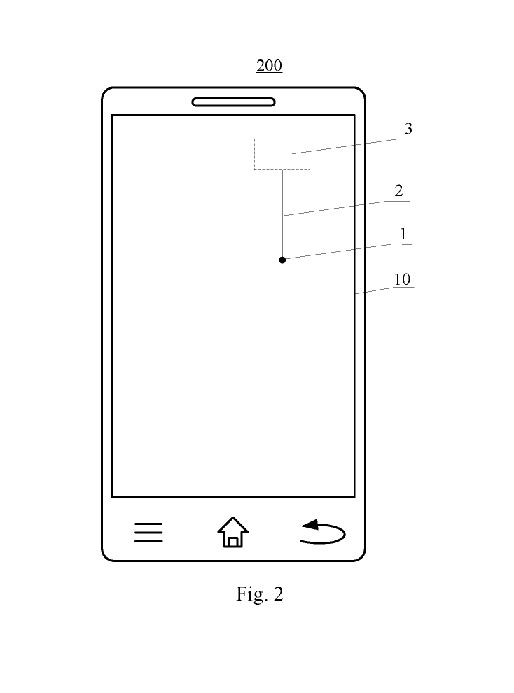

FIG. 2 is a schematic view of a screen assembly 200 of a mobile device according to an exemplary embodiment of the present disclosure. As shown in FIG. 2, the screen assembly 200 includes the display region 10, the light sensor 1, a data transmission wire 2, and a processing component 3. The light sensor 1 is arranged within the display region 10 and is configured to acquire data representing ambient light for the mobile device. The data transmission wire 2 is coupled to the light sensor 1 at one end and to the processing component 3 at the other end. The data transmission wire 2 is configured to transmit data acquired by the light sensor 1 to the processing component 3. According to the present disclosure, the processing component 3 may be a single processing chip such as a Microcontroller Unit (MCU), or a module including a plurality of components performing processing function.

Consistent with the present disclosure, the display region 10 refers to a region on the screen assembly for implementing the display function. For example, the display region 10 corresponds to a view area region of an LCD display module of the screen assembly 200.

According to the present disclosure, the light sensor 1 is provided within the display region 10 of the screen assembly 200 of the mobile device such that the light sensor 1 can directly collect the ambient light at the display region 10 without any space between the light sensor 1 and the display region 10. Therefore, the light sensor 1 can more accurately detect the ambient light condition for the display region 10.

Moreover, the display region 10 may include a transparent structure, such as a glass panel. The light sensor 1 can be arranged directly behind the glass panel. Therefore, there is no need to provide a hole on the panel of the mobile device for the light sensor 1. Thus, the strength and the aesthetic appearance of the screen assembly 200 of the mobile device can be maintained intact.

In addition, since the light sensor 1 directly detects ambient light of the mobile device through the glass panel of the screen assembly 200 at the display region 10 without the need for a hole, light collection of the light sensor 1 is not influenced by the size of a hole. Accordingly, the detection angle of the light sensor 1 can be improved, and the collected ambient light condition can more accurately represent the actual ambient light condition of the mobile device. As such, the mobile device can adjust the brightness of the screen more accurately.

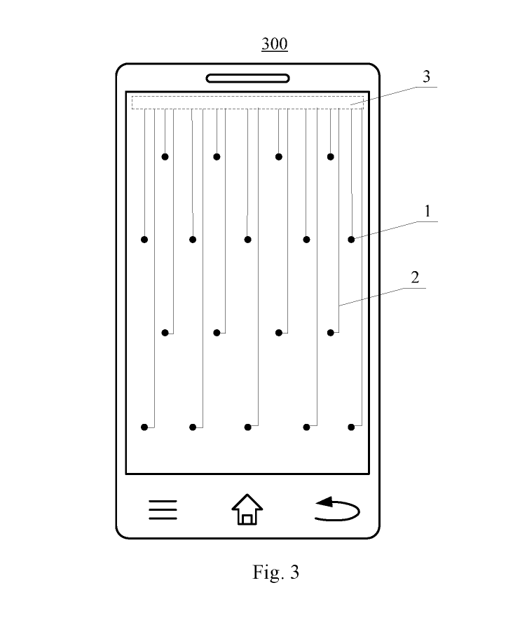

The screen assembly 200 shown in FIG. 2 has one light sensor 1. However, more light sensors 1 can be provided. For example, FIG. 3 shows a screen assembly 300 according to another exemplary embodiment of the present disclosure. The screen assembly 300 includes a plurality of light sensors 1 evenly arranged within the display region 10, so as to more thoroughly and finely collect the ambient light of the mobile device. As shown in FIG. 3, each of the light sensors 1 is coupled to the processing component 3 via a corresponding data transmission wire 2.

FIG. 4 shows a screen assembly 400 according to another exemplary embodiment of the present disclosure. The screen assembly 400 is similar to the screen assembly 200, except that the screen assembly 400 further includes a touch screen structure 4. FIG. 4 also shows a partial enlarged view of the touch screen structure 4. As shown in FIG. 4, the touch screen structure 4 has a conductive layer, which contains a plurality of electrodes arranged in accordance with a preset pattern. For example, in FIG. 4, the conductive layer includes a plurality of diamond-shaped electrodes arranged sequentially in a staggered manner. The electrodes include a first type of electrodes 41 (solid diamonds in FIG. 4) and a second type of electrodes 42 (hatched diamonds in FIG. 4) interlaced with each other. As shown in FIG. 4, horizontally adjacent first type electrodes 41 are coupled to each other while vertically adjacent second type electrodes 42 are coupled to each other.

According to the present disclosure, a vertical projection of the light sensor 1 is located within a vertical projection of a gap among neighboring electrodes, as shown in FIG. 4. In other words, the light sensor 1 is disposed in a gap among electrodes. However, the light sensor 1 can be at the same level as the conductive layer, or can be at a different level. Arranging the light sensor 1 and the conductive layer of the touch screen structure 4 on different levels can prevent the light sensor 1 from influencing the operation of the conductive layer. Moreover, the conductive layer and the light sensor 1 can be separately manufactured during the production of the screen assembly 400.

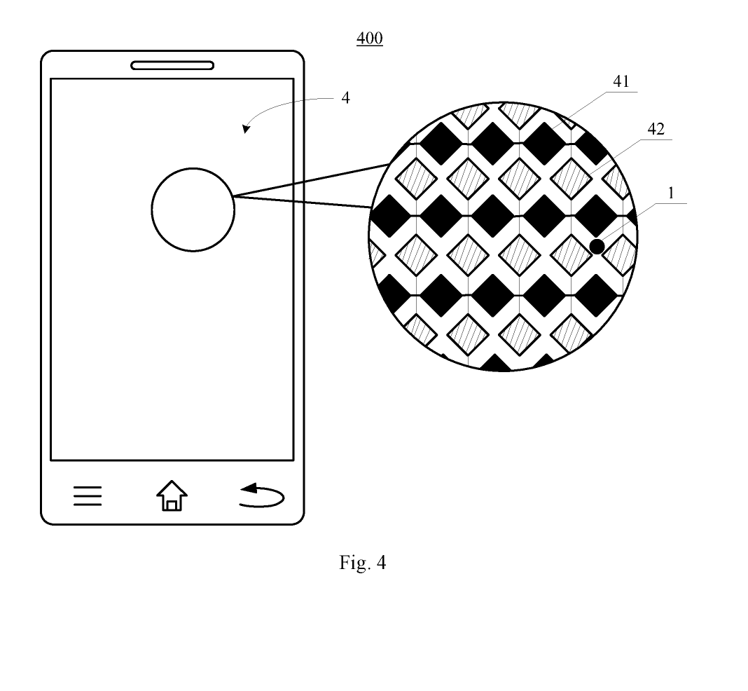

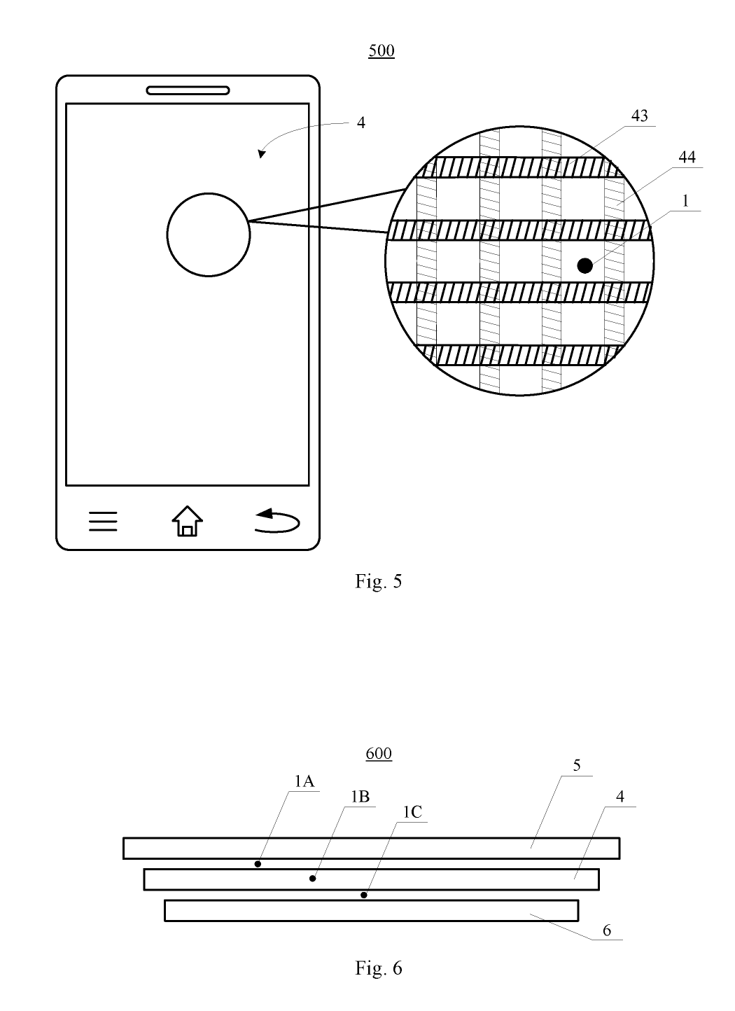

The shape and arrangement of the electrodes consistent with the present disclosure are not limited to those shown in FIG. 4. Those skilled in the art can design and adopt any other forms of pattern as desired, and they are all applicable to the technical solution of the present disclosure, as long as a vertical projection of the light sensor 1 is located within a vertical projection of a gap among neighboring electrodes. For example, FIG. 5 shows another exemplary screen assembly 500 having another form of pattern containing strip-shaped horizontal electrodes 43 and vertical electrodes 44. In the screen assembly 500, the light sensor 1 is arranged in a gap among some of the electrodes 43 and the electrodes 44.

FIG. 6 is a cross-sectional view of a screen assembly 600 according to another exemplary embodiment of the present disclosure. The screen assembly 600 has an “outer-hanging” structure, in which the touch screen structure 4 is disposed between a glass panel 5 and an LCD display module 6. The “outer-hanging” structure can be a type of, e.g., GG, GG2, OGS, G1F, GFF, GF2, GF, or the like.

As shown in FIG. 6, the screen assembly 600 may include a light sensor 1A arranged between the touch screen structure 4 and the glass panel 5. For example, during the manufacturing of the screen assembly 600, the light sensor 1A can be disposed at the top surface of the touch screen structure 4 or the bottom surface of the glass panel 5, and then the touch screen structure 4 and the glass panel 5 are bonded together so that the light sensor 1A is located in a bonding layer between the touch screen structure 4 and the glass panel 5.

Alternatively, as shown in FIG. 6, the screen assembly 600 may include a light sensor 1B arranged in the touch screen structure 4. With this configuration, there is no need to bond the touch screen structure 4 and the glass panel 5.

Alternatively, as shown in FIG. 6, the screen assembly 600 may include a light sensor 1C arranged between the touch screen structure 4 and the LCD display module 6. For example, during the manufacturing of the screen assembly 600, the light sensor 1C can be disposed at the bottom surface of the touch screen structure 4 or the top surface of the LCD display module 6, and then the touch screen structure 4 and the LCD display module 6 are bonded together so that the light sensor 1C is located in a bonding layer between the touch screen structure 4 and the LCD display module 6.

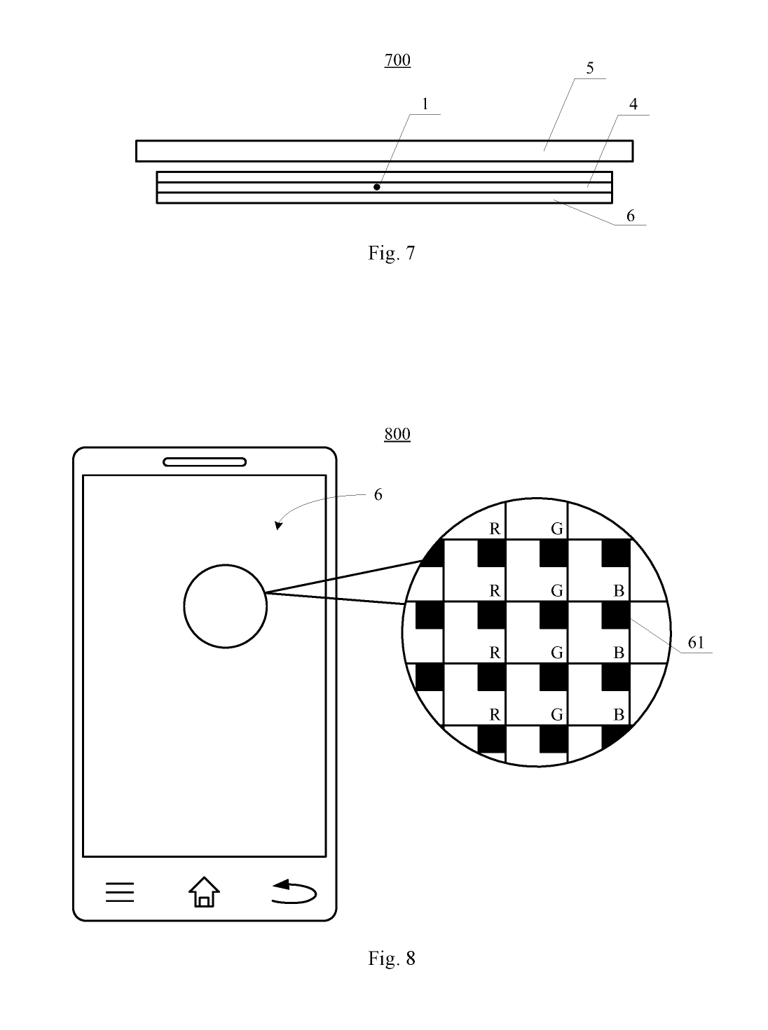

FIG. 7 is a cross-sectional view of a screen assembly 700 according to another exemplary embodiment of the present disclosure. As shown in FIG. 7, the screen assembly 700 has an “embedded in” structure in which the touch screen structure 4 is embedded in the LCD display module 6. The “embedded in” structure can be a type such as On-cell, In-cell, or the like. Correspondingly, the light sensor 1 is disposed in the touchscreen structure 4.

In some embodiments, the light sensor 1 can be made of a transparent material, to avoid influence on the display of the LCD display module 6.

In some embodiments, the volume of the light sensor 1 can be reduced such that the user does not recognize the light sensor 1 when watching the mobile device with the naked eye, to avoid influence on the display of the LCD display module 6.

FIG. 8 shows a screen assembly 800 according to another exemplary embodiment of the present disclosure. The screen assembly 800 includes a plurality of sub-pixels arranged adjacent to each other and provided on a color filter, a part of which is shown in the partially enlarged view of FIG. 8. In FIG. 8, the rectangles disposed adjacent to each other represent the sub-pixels, in which R, and B sub-pixel correspond to Red, Green, and Blue colors. Each sub-pixel contains a Black Matrix (BM) region 61, which is not for displaying the color of the corresponding sub-pixel. Accordingly, the vertical projection of the light sensor 1 can be located within a vertical projection of a BM region 61 of a sub-pixel of the LCD display module 6. Thereby, even if the light sensor 1 has a large volume or is not made of transparent material, it would not influence the display of the LCD display module 6.

According to the present disclosure, to avoid the influence of the light sensor 1 on both the touch screen structure 4 and the LCD display module 6, the vertical projection of the light sensor 1 should be located within a vertical projection of a gap among some of the electrodes of the conductive layer of the touch screen structure 4 and within a vertical projection of a BM region 61 of a sub-pixel of the LCD display module 6.

Other embodiments of the present disclosure will be apparent to those skilled in the art from consideration of the specification and practice of the present disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A screen assembly, comprising:
a display region;
a light sensor arranged within the display region and configured to acquire data representing ambient light of the screen assembly; and
a data transmission wire coupled to the light sensor at one end and a processing component at another end, and configured to transmit the data acquired by the light sensor to the processing component.

2. The screen assembly according to claim 1, further comprising:
a touch screen structure having a conductive layer that contains a plurality of electrodes arranged in accordance with a preset pattern,
wherein a vertical projection of the light sensor is located within a vertical projection of a gap among some of the electrodes.

3. The screen assembly according to claim 2, wherein the light sensor is made of a transparent material.

4. The screen assembly according to claim 2, further comprising:
a glass panel; and
an LCD display module,
wherein:
the touch screen structure is arranged between the glass panel and the LCD display module, and
the light sensor is arranged in the touch screen structure, between the touch screen structure and the glass panel, or between the touch screen structure and the LCD display module.

5. The screen assembly according to claim 2, further comprising:
a glass panel; and
an LCD display module,
wherein:
the touch screen structure is embedded in the LCD display module, and
the light sensor is arranged in the touch screen structure.

6. The screen assembly according to claim 1, further comprising:
an LCD display module,
wherein a vertical projection of the light sensor is located within a vertical projection of a black matrix region of a sub-pixel of the LCD display module.

7. The screen assembly according to claim 1, wherein the screen assembly includes a plurality of evenly-arranged light sensors.

8. A mobile device, comprising a screen assembly according to claim 1.

9. The mobile device according to claim 8, wherein the screen assembly further includes a touch screen structure having a conductive layer that contains a plurality of electrodes arranged in accordance with a preset pattern, a vertical projection of the light sensor being located within a vertical projection of a gap among some of the electrodes.

10. The mobile device according to claim 9, wherein the light sensor is made of transparent material.

11. The mobile device according to claim 9, wherein the screen assembly further includes a glass panel and an LCD display module, the touch screen structure being arranged between the glass panel and the LCD display module, and the light sensor being arranged in the touch screen structure, between the touch screen structure and the glass panel, or between the touch screen structure and the LCD display module.

12. The mobile device according to claim 9, wherein the screen assembly further includes a glass panel and an LCD display module, the touch screen structure being embedded in the LCD display module, and the light sensor being arranged in the touch screen structure.

13. The mobile device according to claim 8, wherein the screen assembly further includes an LCD display module, a vertical projection of the light sensor being located within a vertical projection of a black matrix region of a sub-pixel of the LCD display module.

14. The mobile device according to claim 8, wherein the screen assembly includes a plurality of evenly-arranged light sensors.
